(19) United States
(12) Patent Application Publication
(10) Pub. No.: US 2007/0288149 A1
(43) Pub. Date: Dec. 13, 2007

(54) Method for Determining a Transmission Ratio in the Drivetrain of a Motor Vehicle

(75) Inventors: Bernd Muller, Friedrichshafen (DE); Wolfgang Groner, Friedrichshafen (DE)

Correspondence Address: DAVIS & BUJOLD, P.L.L.C., 112 PLEASANT STREET, CONCORD, NH, 03301, US

(73) Assignee: ZF Friedrichshafen AG, Friedrichshafen (DE)

(21) Appl. No.: 11/659,677

(22) PCT Filed: Jul. 5, 2005
(86) PCT No.: PCT/EP05/07231

§ 371 Date: Feb. 7, 2007

(30) Foreign Application Priority Data
Aug. 13, 2004 (DE) 10 2004 039 272.2

(51) Int. Cl. G06F 7/00

(52) U.S. Cl. 701/51

(57) ABSTRACT

A method for determining a gear transmission ratio in the drivetrain of a motor vehicle having an engine, a clutch and a variable speed gearbox. A gear transmission ratio between the engine and the variable speed gearbox being determined from the rotational speed of the output shaft of the engine and the rotational speed of the output shaft of the variable speed gearbox. A method having additional steps of determining an amount of the current speed of the motor vehicle and processing the value of the current rotational speed of the output shaft of the variable speed gearbox and the value of the current speed of the motor vehicle using a processing unit so that the gear transmission ratio of the vehicle components of the drivetrain located downstream of the variable speed gearbox is determined.

This application is a national stage completion of PCT/EP2005/007231 filed Jul. 5, 2005, which claims priority from German Application Serial No. 10 2004 039 272.2 filed Aug. 13, 2004.

### FIELD OF THE INVENTION

The invention relates to a method for determining a gear transmission ratio in the drivetrain of a motor vehicle.

### BACKGROUND OF THE INVENTION

It is known that in a motor vehicle drivetrain, a clutch and a variable speed gearbox are disposed downstream of a driving motor from a drive point of view.

The variable speed gearbox, among other things, has the function of converting the engine speed and the engine torque. As a result of these changes, the speeds and torque developing on the driven wheels of the vehicle correspond to the desired driving speeds with sufficiently high driving torque and/or traction forces.

The change of the torque and the engine speed is achieved in that different gear ratios are set in the variable speed gearbox. The respective gear transmission ratio is determined by comparing a rotational speed nₘ of the output shaft of the engine or the drive shaft of the gearbox with the engine speed n_{wg} of the drive shaft of the variable speed gearbox. The gear transmission ratio between the output shaft of the engine or drive shaft of the gearbox and the output shaft of the variable speed gearbox is defined by the following equation: i₁=n_{wg}/nₘ. If the engine speed n_{wg} of the output shaft of the variable speed gearbox is known and if no other components that influence the engine speed are present in the drivetrain to the driven wheel, the engine speed of at least one vehicle driven wheel is determined from the engine speed of the output shaft of the variable speed gearbox.

During the course of use of a vehicle, however, situations may arise in which the components disposed downstream of the variable speed gearbox may influence the actual gear transmission ratio. This occurs, for example, when installing a rear axle with axle drive when building or converting the motor vehicle, using an axle drive that has a different ratio than that of the previously used rear axle.

A different cause for the change of the gear transmission ratio in the drivetrain may be a shiftable transfer case, the regulating step of which was changed. A transfer case, which is disposed between the variable speed gearbox and axle drive, may be used to drive several vehicle axles simultaneously. A further task of the transfer case may be to achieve speed compensation between the axle drives in vehicles with constant all-wheel drive or to block speed compensation when there is excessive slip differences between the drive wheels. In the case of all-terrain vehicles or commercial vehicles, the transfer case is also used to expand the gear transmission ratio range. It is possible that no exact information is available as to the extent to which the gear transmission ratio in the drivetrain is influenced.

A further cause as to why in components of the drivetrain, which are disposed downstream of the variable speed gearbox, a changed gear transmission ratio may be due to the drive wheels. When changing wheels using wheels that have a different diameter than the previously used wheels, compared to the previously used wheels, a different rolling length is created resulting in a different vehicle speed. A change of diameter may also be the result of lowering the air pressure while driving, for example, to improve traction. The use of a vehicle is also associated with tire wear so that over time the wheel diameter decreases. These influences may mean that the gear ratio is in part or completely unknown so that no or only erroneous signal variables are available for the driving strategy, clutch control and transmission control.

Against this background it is the object of the invention to determine a method, which allows the driving strategy, clutch control and transmission control to be optimally and easily adjusted during the entire service life of a vehicle.

### SUMMARY OF THE INVENTION

The invention is based on the realization that the determination of individual ratios of components in the drivetrain, which are disposed downstream of the variable speed gearbox to the driven wheel, is not possible with acceptable levels of effort. Therefore, according to the invention, a method is used to determine an overall gear transmission ratio of the components disposed downstream of the variable speed gearbox.

Accordingly, the invention is based on a method for determining a gear transmission ratio in the drivetrain of a motor vehicle with an engine, a downstream clutch and a variable speed gearbox downstream thereof wherein, between the engine and the variable speed gearbox, a gear ratio is determined by the current rotational speed of the output shaft of the engine and the current rotational speed of the output shaft of the variable speed gearbox.

In addition, it is provided that the method includes the following steps:

determining the amount of the current speed of the motor vehicle and processing the amount of the current rotational speed of the output shaft of the variable speed gearbox and the amount of the current speed of the motor vehicle using a processing unit so that the gear transmission ratio is determined based on the vehicle components of the drivetrain disposed downstream of the variable speed gearbox.

In addition, it is preferable that the processing unit forms the product of the amount of the current rotational speed of the output shaft of the variable speed gearbox and the reciprocal value of the amount of the vehicle speed. This is advantageous, because a variable can be formed from the total gear ratio of the components downstream of the variable speed gearbox as a function of the dynamic wheel diameter. Since this variable remains constant for a foreseeable period, the failure of a speed sensor on the driven wheel or of a speed sensor on the output shaft of the variable speed gearbox can be compensated.

In addition, in a preferred embodiment, it may be provided that the method is only conducted when the current vehicle speed exceeds a minimum amount. This is advantageous because the uncertainty and/or the error ranges are kept small when determining the gear ratio.

Furthermore, it may be provided that the amount of the current engine speed of the driven shaft of the variable speed gearbox and/or the amount of the current vehicle speed are captured at different cycle speeds. This is advantageous because, as a result, sensors and transducers may be used, which provide updated readings at different times.

In addition, it is considered advantageous that if the processing unit only processes the above amounts when a change of the amount captured with the lower cycle rate occurs. This is advantageous because, as a result, only readings are included in the determination of the gear ratio, which together represent the most up-to-date reading. Consequently, it can be avoided using readings for the computation of the gear ratio that were measured at different times and, therefore, different events.

In addition, it may be provided that the processing unit only processes the amounts when the amount of an acceleration of the current engine speed of the output shaft does not exceed a certain value. This is advantageous because with this, mechanical deformation forces occurring in the drivetrain when starting to drive (so-called wind-up effects) can only act as insignificant disturbance variables in the determination of the gear ratio.

According to another embodiment of the invention, it may be provided that the processing unit repeats the processing operations of the above amounts until the determined gear transmission ratio does not exceed a defined tolerance. This is advantageous because with this only a determined gear ratio, which is only associated with a very small measuring uncertainty, is used as a signal variable for the transmission control, clutch control, and driving strategy.

Finally, it may be preferable that the processing unit determines a replacement value instead of a computed value. This is advantageous because, for example, in the event that a determined gear transmission ratio drops below a minimum gear transmission ratio, such a replacement value is used and the transmission control and the clutch control and driving strategy are not based on a value that is technically obviously not sensible.

### BRIEF DESCRIPTION OF THE DRAWINGS

The invention will now be described, by way of example, with reference to the accompanying drawings in which:

FIG. 1 is a schematic top view of the motor vehicle drivetrain;

FIG. 2A is a graphical illustration to explain the erroneous computation when determining the gear transmission ratio according to one embodiment of the invention;

FIG. 2B is a tabular representation showing uncertainty values of computer gear transmission ratios as shown in FIG. 2A;

FIG. 3 is a schematic illustration to explain the determination of the gear transmission ratio according to another embodiment of the invention, and

FIG. 4 is a schematic illustration to explain the determination of the gear transmission ratio according to a further embodiment of the invention.

### DETAILED DESCRIPTION OF THE INVENTION

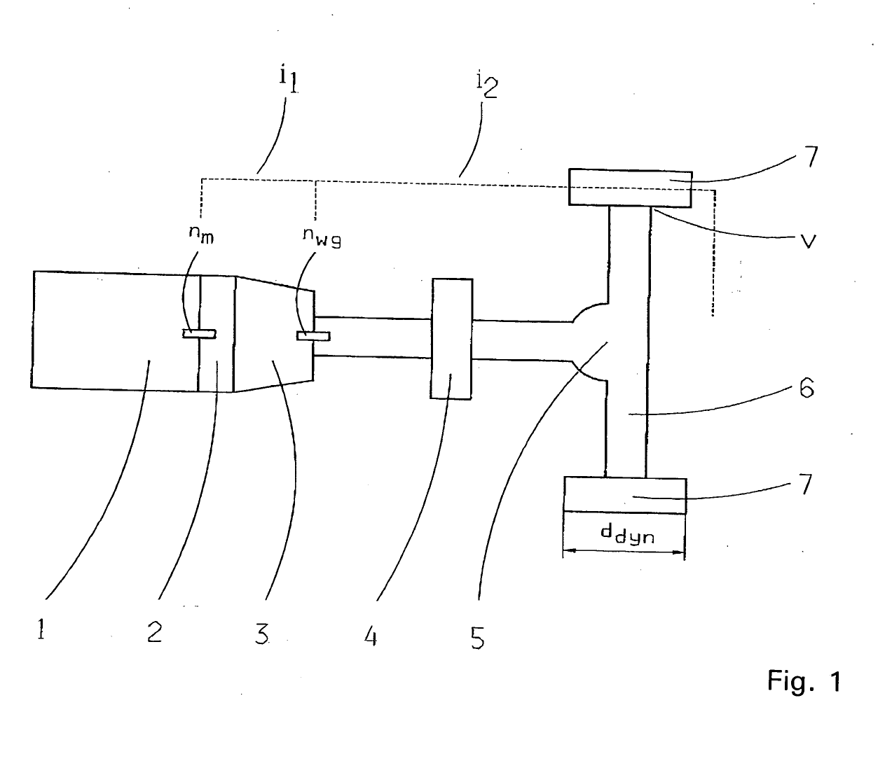

FIG. 1 shows that the drivetrain of a motor vehicle has an engine 1, a downstream clutch 2 from a drive point of view and a downstream variable speed gearbox 3. The engine 1 on the output shaft has a rotational speed nₘ, which is transmitted from there to the variable speed gearbox 3 when the clutch 2 is engaged. There, a torque conversion and speed conversion take place so that the driven shaft of the variable speed gearbox 3 rotates at a speed n_{wg}.

The gear ratio between the engine and the variable speed gearbox is known to be calculated with the equation i₁=nₘ/n_{wg}. On the driven shaft of the variable speed gearbox 3, the rotational speed is forwarded from the drivetrain to a possibly integrated transfer case 4 and from there to an axle drive 5. There, the power flow is diverted by 90° so that the rear axle 6, disposed transversely to the longitudinal axis of the vehicle, are driven. Rear wheels 7 of the vehicle are provided at the ends of the rear axle 6.

According to one embodiment of the invention, the current vehicle speed is measured on a rear wheel 7, allowing the speed n_{wg} to be used to determine a relative gear transmission ratio based on the following formula.

$$\frac{{i}_{2}}{{d}_{dyn}} = π \frac{{n}_{wg}}{v}$$

Here, i₂ is the gear transmission ratio of the output shaft of the variable speed gearbox 3 to the driven wheel 7; d_{dyn} is the dynamic wheel diameter of the wheels 7; n_{wg} is the rotational speed of the output shaft of the variable speed gearbox, and v is the speed of the wheels 7. The term i₂ denotes the total gear transmission ratio, which includes all individual ratios of the components present between the variable speed gearbox 3 and the rear wheel 7. In FIG. 1, this region of the drivetrain is shown with a dotted line. When the relative gear transmission ratio determined with formula (1) is known, the following problems can be solved:

a) Failure of a speed sensor or failure of an engine speed sensor in the drivetrain: Since the ratio i₂/d_{dyn} remains constant for a foreseeable period, a suddenly missing value of a speed sensor and/or of an engine speed sensor can be computed.

b) Unknown gear ratio of a transfer case: If the dynamic wheel diameter d_{dyn} is known, the gear transmission ratio i₂ can be determined with the captured vehicle speed v and the captured engine speed n_{wg} of the variable speed gearbox 3. In addition, if the gear ratio of the axle drive 5 is known, the gear ratio of a transfer case 4 can be calculated.

c) Unknown dynamic wheel diameter: If the gear transmission ratio i₂, the engine speed n_{wg} on the output shaft of the variable speed gearbox 3 and the vehicle speed v are known, the dynamic wheel diameter can be determined. If any wheels are replaced, the tires are worn or the air pressure decreases during the service life of a vehicle, the dynamic diameter of a wheel will change, which can be determined using formula (1).

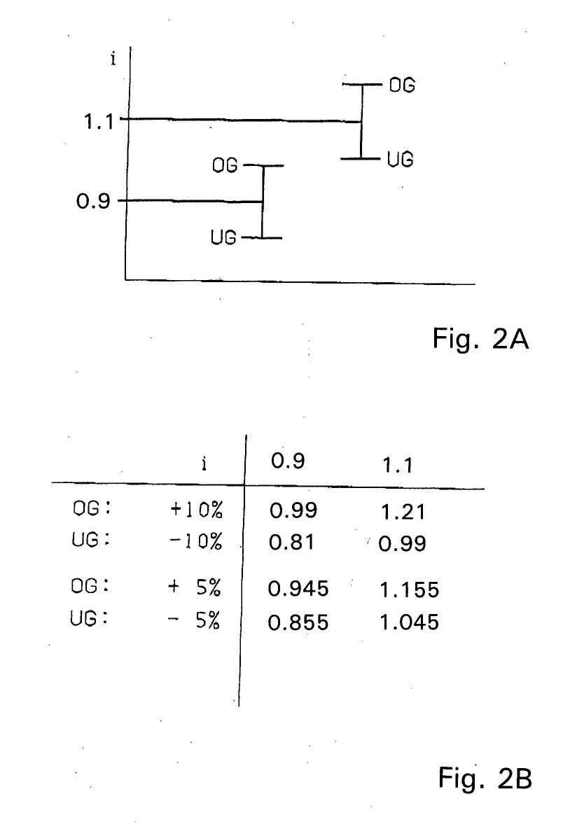

When determining the gear transmission ratio i₂, care should be taken that the measuring uncertainty levels or errors occurring in the detection of a reading are not so large that it results in an error for the gear ratio. The following example will illustrate this in conjunction with FIGS. 2A and 2B.

If a shiftable transfer case has a control stage with a first gear ratio of 1:0.9 and a control stage with a second gear ratio of 1:1.1, these gear ratios can be clearly differentiated from each other if the measurements are read without error. In practice, however, each measurement signal is associated with a certain measurement uncertainty.

It shall be assumed that the gear transmission ratio is known with an uncertainty of ±10%. This produces an error range with a lower limit UG and an upper limit OG at the amounts illustrated in the table in FIGS. 2A and 2B. At the first gear ratio of 1:0.9, an uncertainty of +10% results in an upper limit OG of 0.99, wherein an uncertainty of −10% results in a lower limit UG of 0.81. At the next control stage with the second gear ratio 1:1.1, the uncertainty of ±10% results in an upper limit OG of 1.21 and in a lower limit UG of 0.99. This demonstrates that the upper limit OG at the first gear ratio of 1:0.9 is equal to the lower limit UG of the second gear ratio of 1:1.1. An uncertainty of ±10%, therefore, means that no clear decision is possible as to whether the shiftable transfer case has a gear ratio of 1:0.9 or 1:1.1. Such situations can be avoided if the uncertainty in determining the gear ratio is lowered significantly and is, for example, only ±5%.

Uncertainties in the determination of a gear transmission ratio may be related to systematic errors. This includes, among other things, slippage on a drive wheel, different cycle rates when determining vehicle speed and/or engine speed of the output shaft of the variable speed gearbox 3 as well as a wind-up effect of the rear axle when starting to drive the motor vehicle. Uncertainties in the determination of the gear transmission ratio can be minimized, for example, if the different cycle rate is taken into consideration in the determination of the signals.

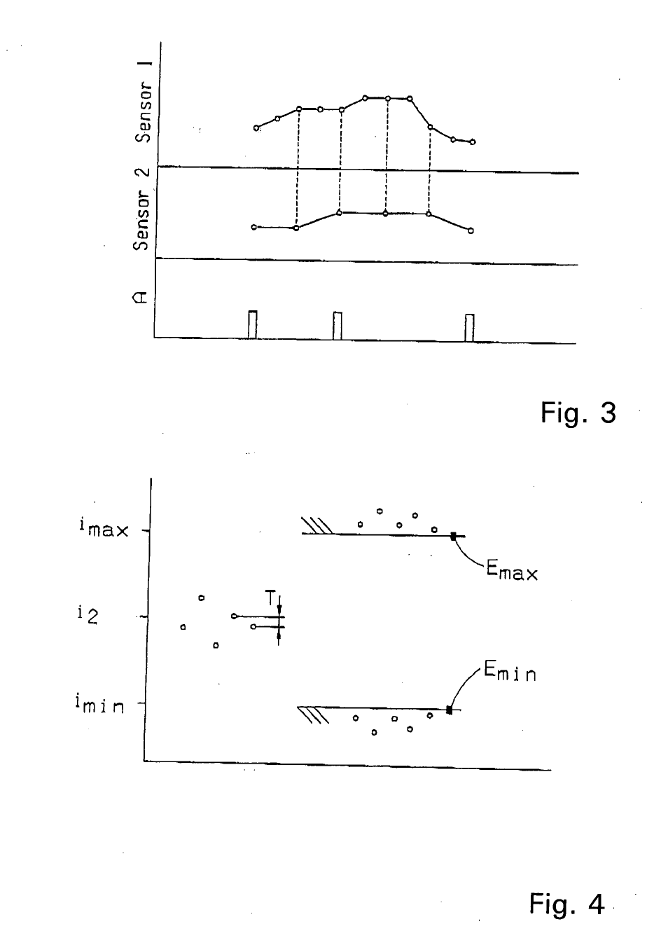

FIG. 3 shows signal lines by way of example which belong to a sensor 1 and a sensor 2. On sensor 1, the signals are captured at a relatively high cycle rate, while a lower cycle rate is used on sensor 2. In the illustrated example, the cycle rate of sensor 1 is twice as high as that of sensor 2.

With respect to determining the gear transmission ratio i₂, for example, sensor 1 may represent the engine speed sensor on the variable speed gearbox 3 and sensor 2 the speed sensor on wheel 7. In order to decide which signal is used for computing the gear transmission ratio i₂, according to the invention, the procedure may be such that a computation of the gear radio i₂ is only carried out when a signal change of sensor 2 with the lower cycle rate is present (see “A” in FIG. 3 with the event bars shown there). As a result, a gear transmission ratio is only computed when newly detected signals are available from both sensors 1 and 2. When an event changes and when a sensor detects this sooner than a second sensor, a gear transmission ratio is determined, which is subject to a relatively high systematic error.

When starting to drive, mechanical deformation and twisting of the entire wheel suspension may occur, the so-called “wind-up effect”. The determination of the gear transmission ratio, according to the invention, may be suspended until the wind-up effect is only associated with a negligible error of the measurement signal. This can be achieved, for example, in that the amount of a change of the acceleration of the current rotational speed of the output shaft of a variable speed gearbox dn_{wg}/dt³ does not exceed a certain value.

A further possibility to reduce the likelihood of a systematic error when determining the gear transmission ratio i₂ is apparent in connection with FIG. 4.

According to this method, a computation according to formula (1) is repeated until the result of a calculation compared to the result of the previous calculation does not exceed a defined tolerance T. A further measure is to use a replacement value Eₘᵢₙ instead of the amounts determined this way when a minimum gear transmission ratio has not been met. The same applies when a maximum possible gear transmission ratio has been exceeded. In this case, a replacement value Eₘₐₓ is selected, see FIG. 4.

If these measures are taken into consideration, systematic errors can be reduced in the determination of the gear transmission ratio.

Reference numerals

1 engine

2 clutch

3 variable speed gearbox

4 transfer case

5 axle drive

6 rear axle

7 rear wheel

i₁ gear transmission ratio of engine to variable speed gearbox

i₂ gear transmission ratio of variable speed gearbox to driven wheel

nₘ engine speed of engine

n_{wg} engine speed of variable speed gearbox

v calibrated vehicle speed

d_{dyn} dynamic wheel diameter

Eₘᵢₙ minimum replacement value

Eₘₐₓ maximum replacement value

T tolerance

A calculation result

1-8. (canceled)

9. A method for determining a gear transmission ratio in the power train of a motor vehicle having in order an engine, a clutch and a variable speed gearbox, a gear ratio between the engine and the variable speed gearbox being determined from a rotational speed of an output shaft of the engine and a rotational speed of an output shaft of the variable speed gearbox, the method comprising the additional steps of:
determining an amount of the current speed of the motor vehicle; and
processing the amount of the current rotational speed of the output shaft of the variable speed gearbox and the amount of the current speed of the motor vehicle using a processing unit,
so that the gear transmission ratio of vehicle components of the power train downstream of the variable speed gearbox is determined, one or more of the amount of the current rotational speed of the output shaft of the variable speed gearbox and the amount of the current speed of the motor vehicle are captured at different cycle rates and that the processing unit only processes these amounts if a change of the respective amount exists, which is collected with the lowest cycle rate.

10. The method according to claim 9, further comprising the step of only processing, with the processing unit, the respective amounts when an amount of an acceleration of the respective current rotational speed of the respective output shaft does not exceed a defined value.

11. The method according to claim 9, further comprising the step of the processing, with the processing unit, the respective amounts until the determined gear ratio does not exceed a defined tolerance.

12. The method according to claim 9, further comprising the step of only carrying out the method for determining the gear transmission ratio in the power train of the motor vehicle, if the current speed of the motor vehicle exceeds a minimum amount.

13. The method according to claim 9, further comprising the step of determining with the processing unit, a replacement value instead of a computed value.

14. A method for determining a gear transmission ratio in the power train of a motor vehicle having, in order, an engine, a clutch and a variable speed gearbox, the method comprising the steps of:
determining a first gear ratio (i₁) between the engine (1) and the variable speed gearbox (3) with a rotational speed (nₘ) of an output shaft (8) of the engine (1) and a value of a current rotational speed (n_{wg}) of an output shaft (9) of the variable speed gearbox (3);
determining a value of a current speed (v) of the motor vehicle;
processing the value of the current rotational speed (n_{wg}) of the output shaft (8) of the variable speed gearbox (3) and the value of a current speed (v) of the motor vehicle with a processing unit (10) to determine a computed value of a second gear transmission ratio (i₂) of vehicle components of the power train downstream of the variable speed gearbox (3);
one or more of the value of the current rotational speed (n_{wg}) of an output shaft (9) of the variable speed gearbox (3) and the value of the current speed (v) of the motor vehicle are determined at different cycle rates and
the processing unit only processing the value of the current rotational speed (n_{wg}) of the output shaft (8) of the variable speed gearbox (3), if the value of the current rotational speed (n_{wg}) of the output shaft (8) of the variable speed gearbox (3), determined with a lowest cycle rate, changes and only processing the value of the current speed (v) of the motor vehicle, if the value of the current speed (v) of the motor vehicle, determined with the lowest cycle rate, changes.

15. The method according to claim 14, further comprising the step of only processing, with the processing unit, the value of the current rotational speed (n_{wg}) of the output shaft (8) of the variable speed gearbox (3), if a value of an acceleration of the of the current rotational speed (n_{wg}) of the output shaft (8) of the variable speed gearbox (3) does not exceed a first defined value and only processing, with the processing unit, the value of the current speed (v) of the motor vehicle, if a value of an acceleration of the value of the current speed (v) of the motor vehicle does not exceed a second defined value

16. The method according to claim 14, further comprising the step of the processing, with the processing unit, the value of the current rotational speed (n_{wg}) of the output shaft (8) of the variable speed gearbox (3), until the second gear transmission ratio (i₂) does not exceed a defined tolerance and processing, with the processing unit, the value of the current speed (v) of the motor vehicle, until the second gear transmission ratio (i₂) does not exceed the defined tolerance.

17. The method according to claim 14, further comprising the step of only determining the second gear transmission ratio (i₂) in the power train of the motor vehicle, if the value of the current speed (v) of the motor vehicle exceeds a minimum amount.

18. The method according to claim 14, further comprising the step of determining with the processing unit, a replacement value instead of the computed value.
